(19) United States
(12) Patent Application Publication
(10) Pub. No.: US 2007/0135331 A1
(43) Pub. Date: Jun. 14, 2007

(54) Clear or translucent liquid fabric softening compositions with improved dispersibility

(76) Inventors: Hugo Jean Marie Demeyere, Merchtem (BE); Karel Geert Claeys, Oostkamp (BE); Mohammed Zuber, Kobe (JP); Frank Hulskotter, Bad Duerkheim (DE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/444,663

(22) Filed: Jun. 1, 2006

Related U.S. Application Data
(60) Provisional application No. 60/687,024, filed on Jun. 3, 2005.

(51) Int. Cl. C11D 3/00

(52) U.S. Cl. 510/515

(57) ABSTRACT

The present invention relates to clear or translucent liquid fabric softening compositions. The composition of the invention comprises a fabric softener, a principal solvent and a non-ionic surfactant.

### CROSS REFERENCE TO RELATED APPLICATION

This application claims the benefit of the filing date of U.S. Provisional Patent Application No. 60/687,024, filed Jun. 3, 2005, the disclosure of which is incorporated by reference herein.

### FIELD OF THE INVENTION

The present invention relates to fabric softening compositions useful for softening fabrics. It especially relates to fabric softening compositions suitable for use in the rinse cycle of a textile laundering operation. The compositions of the invention are translucent or clear liquid softening compositions.

### BACKGROUND OF THE INVENTION

Clear or translucent fabric softening compositions have been described. It is well appreciated that fabric softening compositions with enhanced dispersibility provide a more efficient and homogeneous fabric softening effect. There is a continuing need to provide clear or translucent fabric softening compositions with enhanced dispersibility.

The use of non-ionic surfactants in clear or translucent softening compositions has been reported. For example, some non-ionic surfactants are believed to help achieve clear products at low solvents levels.

There is a need to identify specific non-ionic surfactants that provide enhanced dispersibility yet still provide clear or translucent products at low solvent levels.

See e.g., U.S. Pat. No. 6,218,354; U.S. Pat. No. 6,302,871; WO 99/09122; WO 01/36575; WO 01/42412; WO 98/02513; WO 97/03169; EP 0 043 547; and EP 0 309 052.

### SUMMARY OF THE INVENTION

The present invention attempts to address this and other needs by providing the use of certain non-ionic surfactants in a clear or translucent fabric softening composition.

A first aspect of the invention provides a clear or translucent fabric softening composition comprising: (a) a fabric softening compound; (b) a principal solvent comprising a ClogP of from −0.2 to 1; and (c) a non-ionic surfactant; wherein the non-ionic surfactant has the following formula:
R³—(CH₂—CH₂—O—)ₓ—(CH—(CH₃)—(CH₂)ₚ—O—)_{y}—R⁴
wherein R³ is a C₄-C₁₈ alkyl chain, R⁴ is H or CH₃, p is 1 or 2, x is an integer from 1 to 10, and y is an integer from 1 to 10.

Another aspect of the invention provides a method of softening fabric comprising the step of administering the composition of the present invention during the rinse cycle of an automatic laundry washing machine.

Another aspect of the invention provides a method of treating fabrics comprising the step of contacting the fabrics in an aqueous medium containing a fabric softening composition of the present invention.

Another aspect of the invention provides a kit comprising a composition of the present invention and optionally instructions instructing the user to administer the composition during the rinse cycle of an automatic laundry washing machine. The user may administer the composition by any known means such as pouring the composition in a compartment in the washing machine that automatically dispenses the composition during a rinse cycle of the washing machine. Another means of dispensing during the rinse cycle is the use of the Downy® Ball.

### DETAILED DESCRIPTION OF THE INVENTION

### I—Non-Ionic Surfactant

A first aspect of the invention provides providing a fabric softening composition comprising a non-ionic surfactant according to the following formula:
R³—(CH₂—CH₂—O—)ₓ—(CH—(CH₃)—(CH₂)ₚ—O—)_{y}—R⁴;
wherein R³ is a C₄-C₁₈ alkyl chain, R⁴ is H or CH₃, p is 1 or 2, x is from 1 to 10 and y is 1 to 10. In one embodiment, R³ is from C₄ to C₁₄, alternatively from C₈ to C₁₈. The alkyl chain of R³ may be branched, unbranched, or cyclic; and substituted or unsubstituted. In another embodiment, variable x is from 1 to 10, alternatively from 5 to 10. In yet another embodiment, variable y is from 1 to 10, alternatively from 5 to 10. In one embodiment, the non-ionic surfactant is a fatty alcohol alkoxylate of the above formula that includes: Plurafac® LF120 and Plurafac® LF405 from BASF. Generally, Plurafac® LF types are low-foaming non-ionic surfactants that consist of alkoxylated Fatty alcohols, and predominantly contain unbranched higher alkene oxides alongside ethylene oxide. Further information about the Plurafac® LF types can be obtained from BASF's technical information brochure dated February 1995.

Typical levels of incorporation of the non-ionic surfactant in the fabric softening compositions of the present invention are of less than 10% by weight, preferably from 0.1% to 7% by weight, more preferably from 1% to 5% by weight of the composition. For purposes of the present invention, these non-ionic surfactants of the present invention are not a “principal solvent” as defined herein below.

Dispersibility

Another aspect of the invention provides a fabric softening composition with enhanced dispersibility. In one embodiment, the composition exhibits a “T50% value” of less than 100 seconds, preferably less than 80 seconds, most preferably less than 75 seconds as measured by the “Fabric Softener Dispersibility Test” or “FSDT. Generally, FSDT quantifies the dispersibility of a fabric softening composition in water by measuring the increase in conductivity that results from the release of electrolyte from the composition into the water as the composition is being dispersed in distilled water. There is a direct relationship between how quickly the composition disperses in water and the kinetics of the increase in conductivity of the water to which the composition is added. As defined herein, the “T50% value” is the time (seconds) needed for the conductivity to increase from the start value (no fabric softener composition added) to the value halfway between the start and end value (added fabric softener composition fully dispersed in the water).

The FSDT has two basic steps. The first step entails generating a set of dilutions of the clear or translucent fabric softening composition in question. A glass jar (with cap to close) having a dimension of about 6 cm wide and 10 cm high is provided. Different dilution levels of the composition are prepared in industrial tap water with a hardness of 2 mmol. To prepare the diluted sample, (150−x) g of tap water is added to the jar, x g of the fabric softener composition is added in a single addition step, the jar is closed and is turned upside down for 3 times at 1 sec per turn and is subsequently immediately put on a shaking table (GFL shaking table type 3020) and shaken for 10 minutes at 200 rpm and subsequently for 2 minutes at 250 rpm (thereby shaking for a total of 12 minutes). The viscosity is measured within one minute after mixing using a Brookfield viscometer type LDV, spindle 2, 60 rpm @ 21-25° C. x is chosen in such a fashion to cover dilutions of 5 w/w %, 10 w/w % up to 95 w/w % at 5 w/w % steps. The diluted sample with the highest viscosity is then used in step 2, the conductivity measurement step.

Step 2 is begun immediately after step 1. 2500 ml of distilled water is placed in a 3 L beaker (21 cm high×15 cm wide). The contents of the 3 L beaker are stirred (IKA Eurostar) @ 50 rpm (using a ‘screw propeller with 4 blades with a 6 cm length). As soon as the contents begin stirring, a conductivity meter (Eutech instruments, handheld conductivity meter) is inserted into the beaker with conductivity measurements taken every 10 seconds. To this water, (117/x) g of the dispersion selected under step 1 is added.

Conductivity measurements are taken consecutively for a first 10 minutes. Thereafter, the speed is increased to 250 rpm and measurements are taken for another 2 minutes (for a total of 12 minutes) to ensure full dispersion of the composition. The time when the conductivity halfway between the start conductivity (no fabric softener composition added) and the conductivity after 12 minutes stirring is reached is reported as the T50% value.

### II—Fabric Softening Compound

Another aspect of the invention provides a fabric softening compound. The fabric softener compound is preferably selected from a cationic, non-ionic, amphoteric or anionic fabric softening component. Typical of the cationic softening components are the quaternary ammonium compounds or amine precursors thereof as defined hereinafter. Typical levels of incorporation of the softening compound in the softening composition are of from 1% to 80% by weight, preferably from 5% to 75%, more preferably from 15% to 70%, and even more preferably from 19% to 65%, by weight of the composition.

Non-limiting examples of fabric softening compounds are provided:

A)-Quaternary Ammonium Fabric Softening Active Compound

1) Preferred quaternary ammonium fabric softening active compound have the formula 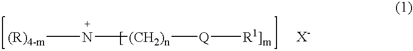
   or the formula: 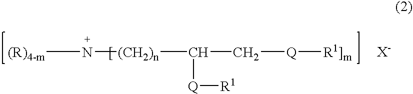
   wherein Q is a carbonyl unit having the formula: 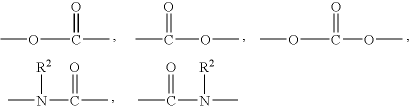
   each R unit is independently hydrogen, C₁-C₆ alkyl, C₁-C₆ hydroxyalkyl, and mixtures thereof, preferably methyl or hydroxy alkyl; each R¹ unit is independently linear or branched C₁₁-C₂₂ alkyl, linear or branched C₁₁-C₂₂ alkenyl, and mixtures thereof, R² is hydrogen, C₁-C₄ alkyl, C₁-C₄ hydroxyalkyl, and mixtures thereof; X is an anion which is compatible with fabric softener actives and adjunct ingredients; the index m is from 1 to 4, preferably 2; the index n is from 1 to 4, preferably 2.

An example of a preferred fabric softener active is a mixture of quaternized amines having the formula: 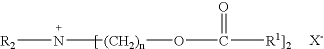
wherein R is preferably methyl; R¹ is a linear or branched alkyl or alkenyl chain comprising at least 11 atoms, preferably at least 15 atoms. In the above fabric softener example, the unit —O₂CR¹ represents a fatty acyl unit which is typically derived from a triglyceride source.

The preferred fabric softening actives of the present invention are the Diester and/or Diamide Quaternary Ammonium (DEQA) compounds, the diesters and diamides having the formula: 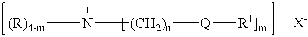
wherein R, R¹, X, and n are the same as defined herein above for formulas (1) and (2), and Q has the formula: 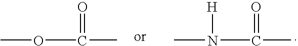
These preferred fabric softening actives are formed from the reaction of an amine with a fatty acyl unit to form an amine intermediate having the formula:

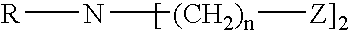

wherein R is preferably methyl, Z is —OH, —NH₂, or mixtures thereof; followed by quaternization to the final softener active. Non-limiting examples of amine used to form the DEQA fabric softening compounds of the present invention are described in US 2002/0035053 A1, published Mar. 21, 2002 at paragraphs 68-73.

As described herein before, R units are preferably methyl, however, suitable fabric softener actives are described by replacing the term “methyl” in the above examples in Table I with the units “ethyl, ethoxy, propyl, propoxy, isopropyl, butyl, isobutyl and t-butyl.

Other DEQA fabric softening compounds described herein that can be used in the preparation of the fabric softening composition herein and having desirable levels of unsaturation, and their syntheses, are described in U.S. Pat. No. 5,877,145, of Errol H. Wahl et al.

Table I. Fabric Softener Compounds

N,N-di(tallowyl-oxy-ethyl)-N,N-dimethyl ammonium chloride;
N,N-di(canolyl-oxy-ethyl)-N,N-dimethyl ammonium chloride;
N,N-di(tallowyl-oxy-ethyl)-N-methyl, N-(2-hydroxyethyl)ammonium chloride;
N,N-di(canolyl-oxy-ethyl)-N-methyl, N-(2-hydroxyethyl)ammonium chloride;
N,N-di(2-tallowyloxy-2-oxo-ethyl)-N,N-dimethyl ammonium chloride;
N,N-di(2-canolyloxy-2-oxo-ethyl)-N,N-dimethyl ammonium chloride
N,N-di(2-tallowyloxyethylcarbonyloxyethyl)-N,N-dimethyl ammonium chloride;
N,N-di(2-canolyloxyethylcarbonyloxyethyl)-N,N-dimethyl ammonium chloride;
N-(2-tallowoyloxy-2-ethyl)-N-(2-tallowyloxy-2-oxo-ethyl)-N,N-dimethyl ammonium chloride;
N-(2-canolyloxy-2-ethyl)-N-(2-canolyloxy-2-oxo-ethyl)-N,N-dimethyl ammonium chloride;
N,N,N-tri(tallowyl-oxy-ethyl)-N-methyl ammonium chloride;
N,N,N-tricanolyl-oxy-ethyl)-N-methyl ammonium chloride;
N-(2-tallowyloxy-2-oxoethyl)-N-(tallowyl)-N,N-dimethyl ammonium chloride;
N-(2-canolyloxy-2-oxoethyl)-N-(canolyl)-N,N-dimethyl ammonium chloride;
1,2-ditallowyloxy-3-N,N,N-trimethylammoniopropane chloride; and
1,2-dicanolyloxy-3-N,N,N-trimethylammoniopropane chloride;
di-tallow dimethyl ammonium chloride;
di-canola dimethyl ammonium chloride.

and mixtures of the above actives.

Other examples of quaternary ammonium softening compounds are methylbis(tallowamidoethyl)(2-hydroxyethyl)ammonium methylsulfate and methylbis(hydrogenated tallowamidoethyl)(2-hydroxyethyl)ammonium methylsulfate; these materials are available from Witco Chemical Company under the trade names Varisoft® 222 and Varisoft® 110, respectively. Particularly preferred are N,N-di(canolyl-oxy-ethyl)-N,N-dimethyl ammonium chloride and N,N-di(canolyl-oxy-ethyl)-N-methyl, N-(2-hydroxyethyl)ammonium methyl sulfate.

The counter ion, X⁻, in the examples of Table I can be suitably replaced by bromide, methylsulfate, formate, sulfate, nitrate, and mixtures thereof. In fact, the anion, X⁻, is merely present as a counterion of the positively charged quaternary ammonium compounds. The scope of this invention is not considered limited to any particular anion.

As used herein, when the diester is specified, it will include the monoester that is normally present in manufacture. For softening, under no/low detergent carry-over laundry conditions the percentage of monoester should be as low as possible, preferably no more than about 2.5%. However, under high detergent carry-over conditions, some monoester is preferred. The overall ratios of diester to monoester are from about 100:1 to about 2:1, preferably from about 50:1 to about 5:1, more preferably from about 13:1 to about 8:1. Under high detergent carry-over conditions, the di/monoester ratio is preferably about 11:1. The level of monoester present can be controlled in the manufacturing of the softener compound.

Mixtures of actives of formula (1) and (2) may also be prepared.

2) Still other suitable quaternary ammonium fabric softening compounds for use herein are cationic nitrogenous salts having two or more long chain acyclic aliphatic C₈-C₂₂ hydrocarbon groups or one said group and an arylalkyl group which can be used either alone or as part of a mixture such as those described in US 2002/0035053 A1 at paragraphs 93 to 99.

B)-Amine Fabric Softening Active Compound

Suitable amine fabric softening compounds for use herein, which may be in amine form or cationic form as described in US 2002/0035053 A1 paragraphs 101 to 127.

Of course, the term “softening compound” can also encompass mixed softening active compounds. Preferred among the classes of softener compounds disclosed herein before are the diester or diamido quaternary ammonium fabric softening active compound (DEQA). The fabric softener actives herein described are employed in clear or translucent formulations. In one embodiment, the composition is clear.

### III—Principal Solvent

Another aspect of the invention provides a principle solvent. The principal solvent is typically used at a level of less than 40% by weight, preferably below 25%, more preferably from 2% to 10%, by weight of the composition.

The principal solvent is selected to minimize solvent odor impact in the composition and to provide a low viscosity to the final composition. For example, isopropyl alcohol is not very effective and has a strong odor. n-Propyl alcohol is more effective, but also has a distinct odor. Several butyl alcohols also have odors but can be used for effective clarity/stability, especially when used as part of a principal solvent system to minimize their odor. The alcohols are also selected for optimum low temperature stability, that is they are able to form compositions that are liquid with acceptable low viscosities and translucent, preferably clear, down to 40° F. (4.4° C.) and are able to recover after storage down to 20° F. (6.7° C.).

The suitability of any principal solvent for the formulation of the liquid, preferably clear, fabric softener compositions herein with the requisite stability is surprisingly selective. Suitable solvents can be selected based upon their octanol/water partition coefficient (P). Octanol/water partition coefficient of a principal solvent is the ratio between its equilibrium concentration in octanol and in water. The partition coefficients of the principal solvent ingredients of this invention are conveniently given in the form of their logarithm to the base 10, logP.

The logP of many ingredients has been reported; for example, the Pomona92 database, available from Daylight Chemical Information Systems, Inc. (Daylight CIS), Irvine, Calif., contains many, along with citations to the original literature. However, the logP values are most conveniently calculated by the “CLOGP” program, also available from Daylight CIS. This program also lists experimental logP values when they are available in the Pomona92 database. The “calculated logP” (ClogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990, incorporated herein by reference). The fragment approach is based on the chemical structure of each ingredient, and takes into account the numbers and types of atoms, the atom connectivity, and chemical bonding. These ClogP values, which are the most reliable and widely used estimates for this physicochemical property, are preferably used instead of the experimental logP values in the selection of the principal solvent ingredients which are useful in the present invention. Other methods that can be used to compute ClogP include, e.g., Crippen's fragmentation method as disclosed in J. Chem. Inf. Comput. Sci., 27, 21 (1987); Viswanadhan's fragmentation method as disclose in J. Chem. Inf. Comput. Sci., 29, 163 (1989); and Broto's method as disclosed in Eur. J. Med. Chem.—Chim. Theor., 19, 71 (1984). The principal solvents herein are selected from those having a ClogP of from −0.2 to 1.0, said principal solvent preferably being at least somewhat asymmetric, and preferably having a melting, or solidification, point that allows it to be liquid at, or near room temperature. Solvents that have a low molecular weight and are biodegradable are also desirable for some purposes. The more asymmetric solvents appear to be very desirable, whereas the highly symmetrical solvents such as 1,7-heptanediol, or 1,4-bis(hydroxymethyl)cyclohexane, which have a center of symmetry, appear to be unable to provide the essential clear compositions when used alone, even though their ClogP values fall in the preferred range.

Operable principal solvents are disclosed and listed below which have ClogP values which fall within the requisite range. These include mono-ols, C6 diols, C7 diols, octanediol isomers, butanediol derivatives, trimethylpentanediol isomers, ethylmethylpentanediol isomers, propyl pentanediol isomers, dimethylhexanediol isomers, ethylhexanediol isomers, methylheptanediol isomers, octanediol isomers, nonanediol isomers, alkyl glyceryl ethers, di(hydroxy alkyl)ethers, and aryl glyceryl ethers, aromatic glyceryl ethers, alicyclic diols and derivatives, C₃C₇ diol alkoxylated derivatives, aromatic diols, and unsaturated diols. These principal solvents are all disclosed in U.S. Pat. No. 6,323,172.

Particularly preferred principal solvents include hexanediols such as 1,2-hexanediol; 2 methyl 2,4 pentanediol and C8 diols such as 2-ethyl-1,3-hexanediol and 2,2,4-trimethyl-1,3-pentanediol, ethoxylates of 2,2,4-trimethyl-1,3-pentanediol and ethoxylates of 2-ethyl-1,3-hexanediol; phenoxyethanol, 1,2 cyclohexanedimethanol and 2 methyl 2,4 pentanediol. Most preferred principal solvents for use herein are selected from 2,2,4-trimethyl-1,3-pentanediol, ethoxylates of 2,2,4-trimethyl-1,3-pentanediol, 1,2 hexanediol, 2-ethyl-1,3-hexanediol, phenoxyethanol, butyl carbitol, 2 methyl 2,4 pentanediol 2 methyl 2,4 pentanediol and mixtures thereof. Even most preferred principal solvents for use herein are selected from 2,2,4-trimethyl-1,3-pentanediol, ethoxylates of 2,2,4-trimethyl-1,3-pentanediol, 1,2 hexanediol, 2-ethyl-1,3-hexanediol, phenoxyethanol, 2 methyl 2,4 pentanediol and mixtures thereof. Mixtures of principal solvents can also be used for the purpose of the present invention.

When in such clear or translucent liquid forms, it has been found preferred, in order to improve the stability of the softening composition according to the invention, that the softening compositions have a pH of from 2 to 5, preferably 2.5 to 4.

### IV—Optional Ingredients

Compositions of the present invention may comprise one or more of the following optional ingredients: low molecular weight water soluble solvents; brighteners; dispersibility aids; soil release agents; scum dispersant; bactericides; perfume; chelating agents; enzymes; and other optional ingredients. US 2002/0035053, from paragraphs 144 to 223.

On aspect of the present invention provide a fabric softening composition free or essentially free of a detersive laundry detergent. In one embodiment, the composition comprises less than 5%, alternatively less than 4%, alternatively less than 3%, alternatively less than 2%, alternatively less than 1%, or alternatively less than 0.5%.

### V. Examples

| | EXAMPLE: | | |
|---|---|---|---|
| | 1 | 2 | 3 |
| N,N-di(canolyl- | 20% | 23% | 25% |
| oxy-ethyl)-N- | | | |
| methyl, N-(2- | | | |
| hydroxyethyl) | | | |
| ammonium methyl | | | |
| sulfate | | | |
| (100% Active) | | | |
| Ethanol | 2.0% | 2.5% | 3.0% |
| Hexyleneglycol | 6% | 5% | 6% |
| Berol 561¹ | 2% | 2.5% | 2% |
| HCl | 0.02% | 0.03% | 0.05% |
| MgCl₂ | 3% | 3% | 4% |
| Plurafac ® LF120² | 1% | 2.5% | 4% |
| Benzyl benzoate | 0.6% | 0.7% | 0.8% |
| Perfume | 0.6% | 0.7% | 0.8% |
| Demin water | Balance | Balance | Balance |

¹Coco, di-polyalkyleneoxy ammonium chloride, commercial material from Akzo,
²nonionic according to the present invention, commercial material from BASF

| | EXAMPLE: | | |
|---|---|---|---|
| | 4 | 5 | 6 |
| N,N-di(canolyl- | 20% | 23% | 25% |
| oxy-ethyl)-N- | | | |
| methyl, N-(2- | | | |
| hydroxyethyl) | | | |
| ammonium methyl | | | |
| sulfate | | | |
| (100% Active) | | | |
| Ethanol | 2.0% | 2.5% | 3.0% |
| Hexyleneglycol | 6% | 5% | 6% |
| Berol 561¹ | 2% | 2.5% | 2% |
| HCl | 0.02% | 0.03% | 0.05% |
| MgCl₂ | 3% | 3% | 4% |
| Plurafac ® LF405³ | 1% | 2.5% | 4% |
| Benzyl benzoate | 0.5% | 0.7% | 0.75% |
| Perfume | 0.6% | 0.7% | 0.8% |
| Demin water | Balance | Balance | Balance |

³nonionic according to the present invention, commercial material from BASF

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

All documents cited in the DETAILED DESCRIPTION OF THE INVENTION are, in relevant part, incorporated herein by reference; the citation of any document is not to be construed as an admission that it is prior art with respect to the present invention

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A clear or translucent fabric softening composition comprising:
a) a fabric softening compound;
b) a principal solvent having a ClogP of from −0.2 to 1.0; and
c) a non-ionic surfactant, wherein said non-ionic surfactant has the following formula:
R³—(CH₂—CH₂—O—)ₓ—(CH—(CH₃)—(CH₂)ₚ—O—)_{y}—R⁴;
wherein:
(i) R³ is a C₄-C₁₈ alkyl chain;
(ii) R⁴ is H or CH₃;
(iii) p is 1 or 2;
(iv) x is an integer from 1 to 10; and
(v) y is an integer from 1 to 10.

2. The composition of claim 1, wherein the composition has a T50% value of less than 75 seconds as measured by the Fabric Softener Dispersibility Test.

3. The composition of claim 2, wherein said softening compound has the formula: 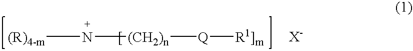
or the formula: 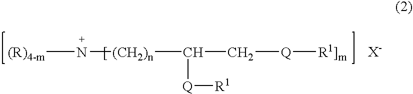
wherein Q is a carbonyl unit having the formula: 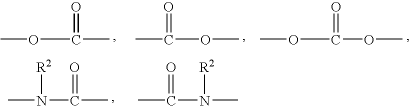
each R unit is independently hydrogen, C₁-C₆ alkyl, C₁-C₆ hydroxyalkyl, and mixtures thereof, preferably methyl or hydroxy alkyl; each R¹ unit is independently linear or branched C₁₁-C₂₂ alkyl, linear or branched C₁₁-C₂₂ alkenyl, and mixtures thereof, R² is hydrogen, C₁-C₄ alkyl, C₁-C₄ hydroxyalkyl, and mixtures thereof; X is an anion which is compatible with fabric softener compound; the index m is from 1 to 4, preferably 2; the index n is from 1 to 4, preferably 2.

4. The composition according to claim 3, wherein said fabric softener compound is present in an amount of from 15% to 70%, by weight of the composition.

5. The composition according to claim 3, wherein said principal solvent is selected from mono-ols, C6 diols, C7 diols, octanediol isomers, butanediol derivatives, trimethylpentanediol isomers, ethylmethylpentanediol isomers, propyl pentanediol isomers, dimethylhexanediol isomers, ethylhexanediol isomers, methylheptanediol isomers, octanediol isomers, nonanediol isomers, alkyl glyceryl ethers, di(hydroxy alkyl)ethers, and aryl glyceryl ethers, aromatic glyceryl ethers, alicyclic diols and derivatives, C₃C₇ diol alkoxylated derivatives, aromatic diols, and unsaturated diols, and mixtures thereof.

6. The composition according to claim 5, wherein the principal solvent is selected from 2,2,4-trimethyl-1,3-pentanediol, ethoxylates of 2,2,4-trimethyl-1,3-pentanediol, 1,2 hexanediol, 2-ethyl-1,3-hexanediol, phenoxyethanol, butyl carbitol, 2 methyl 2,4 pentanediol, and mixtures thereof.

7. The composition according to claim 6, wherein said principal solvent is present from about 2% to about 10%, by weight of the composition.

8. The composition according to claim 7, wherein said composition comprises an effective amount, sufficient to improve clarity, of low molecular weight water soluble solvents selected from the group consisting of: ethanol, isopropanol, propylene glycol, 1,2-propanediol; 1,3-propanediol, propylene carbonate, 1,4 cyclohexanedimethanol and mixtures thereof.

9. The composition according to claim 8, wherein said composition has a pH of from 2 to 5 and is essentially free of a detersive laundry detergent.

10. A method of treating fabrics comprising the step of contacting the fabrics in an aqueous medium containing the softening composition as defined by claim 9.
